(19) United States
(12) Patent Application Publication
(10) Pub. No.: US 2019/0262792 A1
(43) Pub. Date: Aug. 29, 2019

(54) Apparatus and System for Forming Solid Carbon Products

(71) Applicant: Seerstone LLC, Provo, UT (US)

(72) Inventor: Dallas B. NOYES, Provo, UT (US)

(73) Assignee: Seerstone LLC, Provo, UT (US)

(21) Appl. No.: 16/320,408

(22) PCT Filed: Jul. 28, 2017
(86) PCT No.: PCT/US2017/044492

§ 371 Date: Jan. 24, 2019

Related U.S. Application Data
(60) Provisional application No. 62/368,020, filed on Jul. 28, 2016.

(51) Int. Cl. B01J 12/00; B01J 19/24; B01J 23/745; B01J 23/755; B01J 35/00; C01B 32/162

(52) U.S. Cl. CPC B01J 12/007; B01J 19/244; B01J 19/2425; B01J 19/249; C01B 32/205; B01J 23/755; B01J 35/002; C01B 32/162; B01J 23/745

(57) ABSTRACT

A reaction apparatus for use in solid carbon production includes a reactor shell defining a reactor inlet and a reactor outlet. Concentric cylinders or substantially parallel plates of catalytic material are disposed within the reactor shell and are structured and adapted to expose at least one contact surface to gaseous reactants. Another apparatus includes a removable cartridge comprising a plurality of substantially parallel plates of catalytic material disposed within the reactor shell. A system for use in carbon nanotube production may include any such reactor and a solids recovery means for removing carbon nanotubes from the reactor.

### PRIORITY CLAIM

This application claims the benefit under 35 U.S.C. § 119(e) and Article 8 of the PCT to U.S. Provisional Patent Application Ser. No. 62/368,020, filed Jul. 28, 2016, for “APPARATUS AND SYSTEM FOR FORMING SOLID CARBON PRODUCTS,” the contents of which are incorporated by this reference.

### FIELD

Embodiments of the present disclosure relate to apparatuses and systems for forming solid carbon products from a carbon source, such as carbon oxides, and a reducing agent, such as hydrogen or hydrocarbons.

### BACKGROUND

U.S. Pat. No. 8,679,444, titled “Method for Producing Solid Carbon by Reducing Carbon Oxides,” and issued Mar. 25, 2014, the disclosure of which is hereby incorporated herein in its entirety by this reference, discloses background information hereto.

Solid carbon has numerous commercial applications. These applications include the longstanding use of carbon black and carbon fibers as filler material in tires, inks, etc.; use of various forms of graphite (e.g., pyrolytic graphite in heat shields); and innovative and emerging applications for nanostructured carbon allotropes including graphene, carbon nanotubes (CNTs), buckminsterfullerenes, and nanodiamonds. CNTs are useful because of their unique material properties, including strength, current-carrying capacity, and thermal and electrical conductivity. Current bulk use of CNTs includes use as additives to resins in the manufacture of composites. Research and development on CNTs is continuing, with a wide variety of applications in use or under consideration. One obstacle to widespread use of nanostructured carbon, however, has been the cost of manufacture. Conventional methods for the manufacture of nanostructured carbon typically involve pyrolysis of hydrocarbons in the presence of a suitable catalyst. Hydrocarbons are typically used as the carbon source, due to abundant availability and relatively low cost.

Carbon oxides, particularly carbon dioxide, are abundant in ambient air and in point-source emissions, such as exhaust gases generated by hydrocarbon combustion or off-gases generated by various industrial processes. Conventional aluminum manufacture, for example, involves the reduction of alumina (Al₂O₃). The process typically uses sacrificial carbon anodes to provide both electrical energy and carbon to reduce the aluminum oxides in the ore. The process forms aluminum and carbon dioxide. Approximately two tons (1.81 metric tons) of carbon dioxide are produced for each ton of alumina that is reduced. Similarly, conventional steel manufacture involves the reduction of the oxides of iron in iron ore or scrap iron. Carbon (in the form of coke or sacrificial carbon anodes) is typically used as the reducing agent in the manufacture of steel, producing large amounts of carbon dioxide. Cement manufacture involves calcination, heating a raw material such as limestone (calcium carbonate) in a kiln, which liberates carbon dioxide. In addition to the carbon dioxide formed during calcination, carbon dioxide may be formed by the combustion of fuels (e.g., coal, natural gas, etc.) used to drive the calcination process, which may be either direct (combustion occurring within the calciner) or indirect (combustion occurring outside the calciner, with resultant heat transferred to the calciner). Worldwide, cement plants contribute about 5% of the total carbon dioxide emitted to the atmosphere from industrial processes. Cement manufacture is also associated with emission of various other waste products, including NOₓ (primarily NO), sulfur compounds (primarily SO₂, with some sulfuric acid and hydrogen sulfide), hydrochloric acid, and particulate matter, including dust. The concentration of carbon dioxide in flue gases from cement plants is typically 15%-30% by volume, significantly higher than in flue gases from power plants (3%-15% by volume). Natural gas production typically starts with well gases containing methane, more than 10% carbon dioxide, and various other minor constituents. The carbon dioxide typically is separated from the methane and other constituents prior to use. Carbon dioxide from well gases may be an economical source of carbon dioxide for large-scale applications using carbon dioxide as an input.

Concerns about greenhouse gases are encouraging industry and governments to find ways to minimize carbon dioxide production and release into the atmosphere. Some methods for reducing carbon dioxide emissions involve capture and sequestration of the carbon dioxide (e.g., by injection into a geological formation). These methods, for example, form the basis for some “green” coal-fired power stations. In current practice, however, capture and sequestration of the carbon dioxide entails significant cost.

There is a spectrum of reactions involving carbon, oxygen, and hydrogen wherein various equilibria have been identified. Hydrocarbon pyrolysis involves equilibria between hydrogen and carbon that favors solid carbon production, typically with little or no oxygen present. The Boudouard reaction, also called the “carbon monoxide disproportionation reaction,” occurs within a region of equilibria between carbon and oxygen that favors solid carbon production, typically with little or no hydrogen present. The Bosch reaction occurs within a region of equilibria where all of carbon, oxygen, and hydrogen are present under reaction conditions that also favor solid carbon production.

The relationship between the hydrocarbon pyrolysis, Boudouard, and Bosch reactions may be understood in terms of a C—H—O equilibrium diagram, as shown in FIG. 1. The C—H—O equilibrium diagram of FIG. 1 shows various known routes to solid carbon, including CNTs. The hydrocarbon pyrolysis reactions occur on the equilibrium line that connects H and C and in the region near the left edge of the triangle to the upper left of the dashed lines. Two dashed lines are shown because the transition between the pyrolysis zone and the Bosch reaction zone may change with reactor temperature. The Boudouard reactions occur on or near the equilibrium line that connects O and C (i.e., the right edge of the triangle). In this zone, the Boudouard reaction is thermodynamically preferred over the Bosch reaction. The equilibrium lines for various temperatures that traverse the diagram show the approximate regions in which solid carbon forms. For each temperature, solid carbon may form in the regions above the associated equilibrium line, but will not generally form in the regions below the equilibrium line. In the region between the pyrolysis zone and the Boudouard reaction zone and above a particular reaction temperature curve, the Bosch reaction is thermodynamically preferred over the Boudouard reaction.

The use of carbon oxides as a carbon source in production of solid carbon has largely been unexploited. The immediate availability of ambient air may provide economical sources of carbon dioxide for local manufacture of solid carbon products at any location. Because point-source emissions have much higher concentrations of carbon dioxide than ambient air, however, they may be economical sources from which to harvest carbon dioxide.

### DISCLOSURE

In some embodiments, a reaction apparatus for use in solid carbon production includes a reactor shell defining a reactor inlet and a reactor outlet. A plurality of concentric cylinders or substantially parallel plates of catalytic material is disposed within the reactor shell structured and adapted to expose at least one contact surface to gaseous reactants within the reactor shell. A system for solid carbon production may include such a reactor and a solids recovery means for removing carbon nanotubes from the reactor.

In other embodiments, an apparatus for use in solid carbon production includes a reactor shell defining a reactor inlet and a reactor outlet. The apparatus includes a diffuser structured and adapted to promote uniform flow through the reactor shell from the reactor inlet to the reactor outlet. The apparatus includes a removable cartridge comprising a plurality of parallel plates or concentric cylinders of catalytic material disposed within the reactor shell.

### BRIEF DESCRIPTION OF THE DRAWINGS

FIG. 1 depicts a C—H—O equilibrium diagram;

FIG. 2 is a simplified exploded view of a reactor for forming solid carbon;

FIGS. 3, 4A, and 4B illustrate details of portions of the reactor shown in FIG. 2;

FIGS. 5, 6, and 7 illustrate different embodiments of cartridges that may be used in the reactor of FIG. 2;

FIG. 8 is a cross-sectional view of a scraper;

FIG. 9 is a simplified exploded view of another apparatus for forming solid carbon;

FIG. 10 is a simplified exploded view of yet another apparatus for forming solid carbon; and

FIG. 11 is simplified schematic diagram of a system for forming solid carbon.

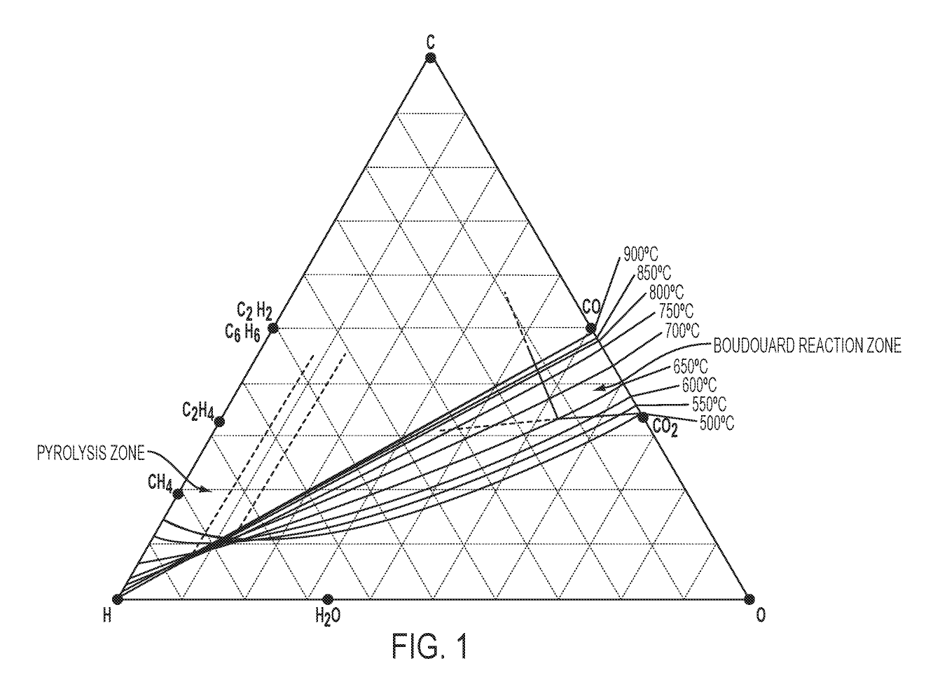

### BRIEF SUMMARY OF MODE(S) FOR CARRYING OUT THE INVENTION

This disclosure includes apparatuses and systems for forming solid nanostructured carbon products, such as carbon nanotubes (CNTs) or carbon nanofibers, from gaseous reactants in reactors having parallel plates, sheets, or cylinders of catalyst material. Reactors disclosed herein include a reactor shell that defines a reactor inlet and a reactor outlet. A diffuser promotes uniform flow of gases through the reactor shell. Gases flow through channels between the parallel plates, sheets, or cylinders of catalyst material. Thus, a relatively large surface area of the catalyst material is exposed to the reaction gases.

As used herein, the term “carbon oxide” means and includes carbon monoxide, carbon dioxide, or any combination of carbon monoxide and carbon dioxide, and optionally including one or more other materials (e.g., nitrogen, argon, helium, methane, oxygen, etc.).

As used herein, the term “catalyst” means and includes a material formulated to promote one or more reactions described herein. A portion of a catalyst may be removed from a surrounding portion of the catalyst during some reactions and contained in or adhered to a solid product, particularly for carbon products. Thus, some of the catalyst may be physically removed during the reaction, and the catalyst may need to be continually replenished. A portion of the catalyst may not therefore be considered a catalyst in the classical sense, but is nonetheless referred to herein and in the art as a “catalyst,” if the reaction is not believed to alter chemical bonds of the material forming the catalyst. Particularly useful catalysts include iron, nickel, cobalt, etc., and alloys and mixtures thereof, as described herein and known to promote carbon synthesis reaction chemistries. Iron carbide (Fe₃C) may be a particularly suitable catalyst. Without being bound to any particular theory, it is believed that the reduction of iron and subsequent carbonization to form iron carbide is a preliminary step in the activation of the catalyst for carbon deposition.

As used herein, the term “solid carbon” refers to any solid carbon including nanostructured carbon, carbon black, graphite, pyrolytic graphite, coke, etc.

As used herein, the term “nanostructured carbon” includes any solid allotrope of carbon or mixture of allotropes with at least one characteristic dimension greater than 1 nanometer and less than 1 micrometer. Nanostructured carbon includes buckminsterfullerenes, CNTs, carbon nanofibers, buckyballs, graphene, nanodiamonds, etc. CNTs are used as specific examples herein and not by way of limitation as to the type of nanostructured carbon that may be produced in the systems and methods disclosed.

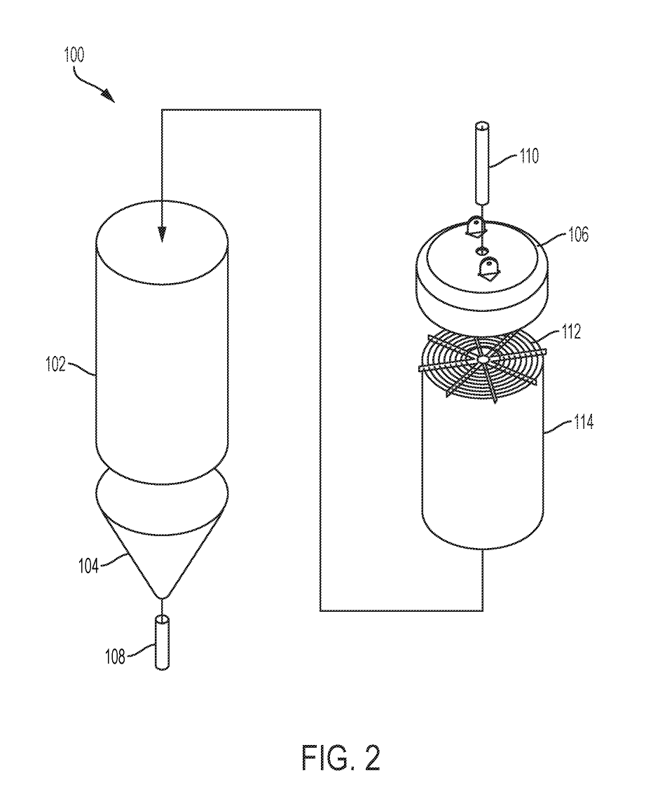

FIG. 2 illustrates an exploded view of a reactor 100 for use in forming solid carbon. The reactor 100 includes a reactor shell in which reactions may occur. The reactor shell includes a body 102, a base 104, and a cap 106. The body 102, base 104, and cap 106 may be separately formed, as shown in FIG. 2, or two or more parts may be integral (e.g., the body 102 may be integrally formed with the base 104). The base 104 may define an outlet 108 from the reactor 100, and the cap 106 may define an inlet 110 to the reactor 100. In some embodiments, the gaseous reactants may flow from the base to the cap so that the relative positions of the outlet 108 and inlet 110 would be reversed. The body 102, base 104, and cap 106 may be formed of a material that is not catalytic for the reaction of gases to be reacted in the reactor 100 at expected operating conditions. That is, the reactor shell may not operate as a catalyst; otherwise, metal dusting and subsequent failure of the reactor shell may ensue. Catalytic material 112 is configured to be placed within the body 102, and may be in the form of a cartridge 114. The cartridge 114 may be removable to facilitate replacement or renewal of the catalytic material 112. Though shown in exploded view for clarity, when the reactor 100 is in operation, the cartridge 114 and the catalytic material 112 are disposed within the body 102, and the cap 106 is secured to the body 102 to form a single unitary reactor shell.

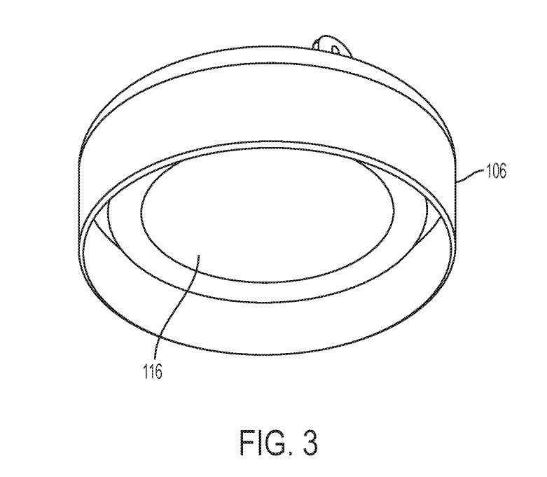

FIG. 3 is a view of the cap 106 and a diffuser 116, which may be secured to the cap 106. The diffuser 116 is structured and adapted to promote uniform flow through the reactor shell from the inlet 110 to the outlet 108. The diffuser 116 may include a porous material, a sintered metal or ceramic, a material having parallel channels (e.g., a honeycomb shape), or any other material capable of making gas flow more uniformly. The diffuser 116 may be a disk or have any other shape appropriate for the shape of the reactor 100. For example, for a cylindrical reactor shell as shown in FIG. 2, a disk-shaped diffuser 116 may be used; for a reactor shaped as a rectangular prism, a rectangular diffuser 116 may be used. The flow rate of gases may be in the turbulent regime, such that the composition of gases is maintained at relatively uniform levels across a cross-section of the reactor 100.

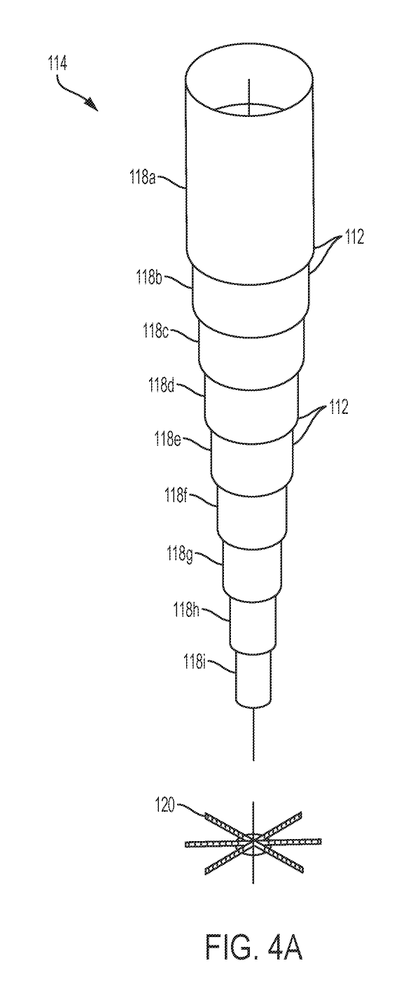

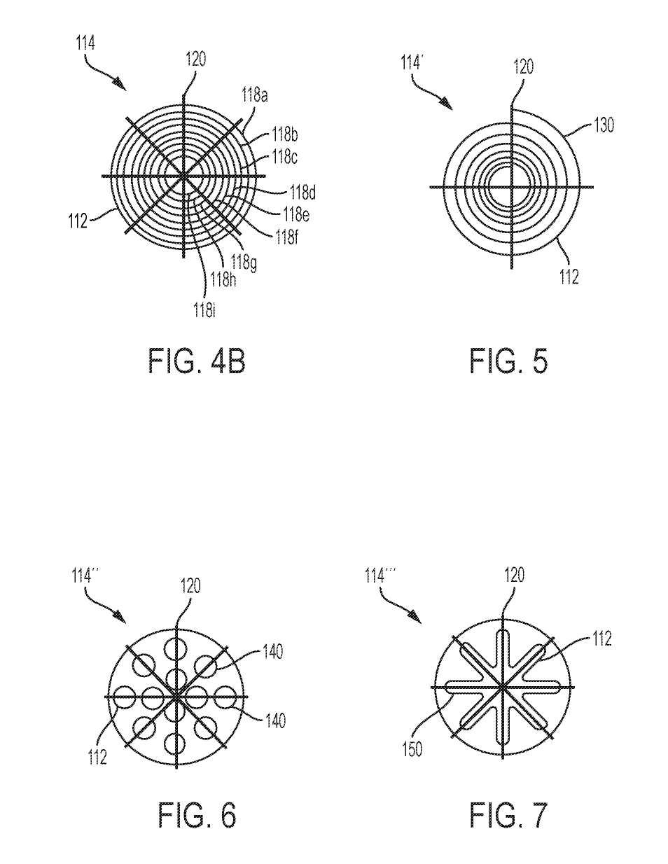

FIG. 4A is an exploded view of the cartridge 114 of catalytic material 112 shown in FIG. 2. The cartridge 114 includes multiple concentric cylinders 118a-118i of catalytic material. The cylinders 118a-118i may be sheets of catalytic material, or may be sheets of a substrate coated with a catalytic material. The cylinders 118a-118i may be formed of a nonporous catalytic material. The cylinders 118a-118i define a plurality of flow paths parallel to the cylinders 118a-118i in a longitudinal direction (i.e., in a direction generally parallel to the axis of the cylinders 118a-118i) through the reactor 100, from the inlet 110 to the outlet 108 (FIG. 2). The cylinders 118a-118i may be held in place by one or more brackets 120. The bracket 120 shown in FIG. 4 includes multiple intersecting bars, to which the cylinders 118a-118i are secured. The cartridge 114 may include multiple brackets 120, such as one bracket 120 at each end of the cylinders 118a-118i. In some embodiments, the brackets 120 may be formed of a metal, a ceramic, a polymer, etc. The brackets 120 provide rigidity and/or stability to the cylinders 118a-118i, such that flow paths through the reactor 100 may be maintained while gases flow therethrough.

FIG. 4B is a top view of the embodiment of the cartridge 114 of catalytic material 112 shown in FIG. 4A.

FIG. 5 is a top view of another embodiment of a cartridge 114′ of catalytic material 112. The cartridge 114′ includes a single helical shaped sheet 130 of catalytic material 112 secured by a bracket 120. FIG. 6 is a top view of a further embodiment of a cartridge 114″ of catalytic material 112. The cartridge 114″ includes a single outer cylinder of catalytic material surrounding a plurality of smaller cylinders 140 of catalytic material oriented in a pattern. FIG. 7 is a top view of yet a further embodiment of a cartridge 114′″ of catalytic material 112. The cartridge 114′″ includes a single outer cylinder of catalytic material surrounding a single sheet of catalytic material 150 disposed in an orientation expanding along the bracket 120 and contracting in areas between arms of the bracket 120.

The catalytic material 112 includes one or more catalysts formulated to promote the formation of solid carbon. Some metals from Groups 2 through 15 of the periodic table, such as from groups 5 through 10, (e.g., nickel, molybdenum, chromium, cobalt, tungsten, iron, manganese, ruthenium, platinum, iridium, etc.) actinides, lanthanides, alloys thereof, and combinations thereof accelerate the reaction rate of carbon oxides with reducing agents under certain conditions. For example, catalysts include iron, nickel, cobalt, molybdenum, tungsten, chromium, and alloys thereof. Note that the periodic table may have various group numbering systems. As used herein, group 2 is the group including Be, group 3 is the group including Sc, group 4 is the group including Ti, group 5 is the group including V, group 6 is the group including Cr, group 7 is the group including Mn, group 8 is the group including Fe, group 9 is the group including Co, group 10 is the group including Ni, group 11 is the group including Cu, group 12 is the group including Zn, group 13 is the group including B, group 14 is the group including C, and group 15 is the group including N. In some embodiments, commercially available metals are used without special preparation. Some suitable catalysts are described in U.S. Pat. No. 8,679,444. Other catalysts are described in, for example, U.S. Patent Application Publication No. 2015/0078981, published Mar. 19, 2015, titled “Methods for Using Metal Catalysts in Carbon Oxide Catalytic Converters,” and U.S. Patent Application Publication No. 2015/0086468, published Mar. 26, 2015, titled “Methods and Structures for Reducing Carbon Oxides with Non-Ferrous Catalysts,” the disclosures of each of which are incorporated herein in their entirety by this reference. Some catalysts facilitate operations at lower temperatures and pressures. In some embodiments, steel (e.g., mild steel) may be used as the catalytic material 112. Suitable catalysts may also include intermetallic compounds (e.g., Ni₃Fe, Fe₃Pt, etc.) or carbides (e.g., cementite (Fe₃C) or silicon carbide (SiC)).

While not intending to be bound by theory, the following may help to explain the results described herein. In the production of the solid carbon, nanoparticles of the catalyst (which may be referred to as “nanocatalyst”) are formed and embedded in the solid carbon. These nanoparticles typically form greater than 0.4% by weight of the solid product. These nanoparticles may remain catalytically active in their solid carbon mounts. Without being bound to a particular theory, it is believed that the grain size and composition of the catalyst, as well as reaction conditions, determine the type and morphology of solid carbon formed.

304 stainless steel appears to catalyze the formation of carbon nanotubes (CNTs) under a wide range of temperatures, pressures, and gas compositions. However, the rate of formation of CNTs on 304 stainless steel appears to be relatively low, such that 304 stainless steel may be used effectively as a construction material for process equipment (e.g., as the body 102, base 104, or cap 106 of the reactor 100), with minimal deposition on surfaces thereof in normal operations. 316L stainless steel, in contrast, appears to catalyze the formation of solid carbon at significantly higher rates than 304 stainless steel, but may also form various morphologies of carbon. Thus, 316L stainless steel may be used as a catalyst to achieve high reaction rates, but particular reaction conditions may be maintained to control product morphology. Catalysts may be selected to include Cr, such as in amounts of about 22% or less by weight. For example, 316L stainless steel contains from about 16% to about 18.5% Cr by weight. Catalysts may also be selected to include Ni, such as in amounts of about 8% or more by weight. For example, 316L stainless steel contains from about 10% to about 14% Ni by weight. Catalysts of these types of steel have iron in an austenitic phase or as cementite (iron carbide), in contrast to alpha-phase iron used as a catalyst in some conventional processes. Given the results observed with 316L stainless steel, the Ni and/or Cr may have a synergistic effect with Fe or iron carbide.

Oxidation and subsequent reduction of the catalyst surface alter the grain structure and grain boundaries of the catalyst. While not intending to be bound by theory, oxidation appears to alter the surface of the metal catalyst in the oxidized areas. Subsequent reduction may result in further alteration of the catalyst surface. Thus, the grain size and grain boundary of the catalyst may be controlled by oxidizing and reducing the catalyst surface and by controlling the exposure time of the catalyst surface to the reducing gas and the oxidizing gas. The oxidation and/or reduction temperatures may be in a range from about 500° C. to about 1,200° C., from about 600° C. to about 1,000° C., or from about 700° C. to about 900° C. The resulting grain size may range from about 0.1 μm to about 500 μm, from about 0.2 μm to about 100 μm, from about 0.5 μm to about 10 μm, or from about 1.0 μm to about 2.0 μm. In some embodiments, the catalyst may be an oxidized metal (e.g., rusted steel) that is reduced before or during a reaction forming solid carbon. While not intending to be bound by theory, it is believed that removal of oxides leaves voids or irregularities in the surface of the catalyst material, and increases the overall surface area of the catalyst material. The subsequent saturation of the iron, forming cementite (iron carbide) appears to be a precursor step to precipitation of solid carbon from the catalyst.

Catalytic material 112 may include, for example, steel or other metals in bulk or as domains or grains and grain boundaries within a solid material. Catalytic material 112 may be selected to have a grain size related to a characteristic dimension of a desired diameter of the solid carbon product (e.g., a CNT diameter). Examples of suitable catalysts include elements of Groups 5 through 10 of the periodic table, actinides, lanthanides, compounds containing such elements, alloys thereof, and other combinations thereof.

Because a portion of the catalyst is typically removed with every CNT, the catalytic material 112 in the reactor 100 may need to be replenished from time to time, based on the catalyst properties (e.g., substantially homogeneous plates or sheets of catalyst, or surface deposited catalyst on inert substrate plates or sheets), reactor properties (e.g., volume) and reaction conditions (e.g., temperature, pressure, etc.). The catalytic material 112 may be replenished by replacing the cartridge 114 or by removing the cartridge 114 and reconditioning the cylinders 118a-118i. The atomic percentage of iron in the CNTs formed in the reactor 100 may be between about 0.5% and 10%.

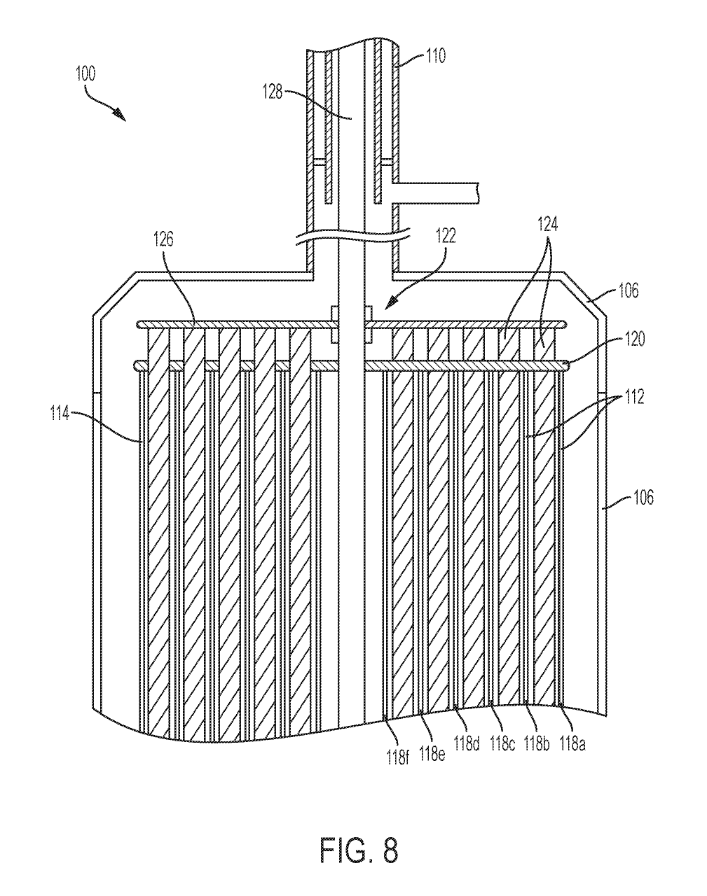

In some embodiments, such as shown in FIG. 8, the reactor 100 may include a scraper 122 configured to remove solid material from surfaces of the catalytic material 112. The scraper 122 may include at least one blade 124 placed between and in proximity to the surfaces of the catalytic material 112. The scraper 122 may further include at least one spreader 126 securing each blade 124 to a central rotating mechanism 128 of the scraper 122. The scraper 122 may include a group of blades 124 within each radial area existing between brackets 120, each blade 124 being placed between and in proximity to the surfaces of the catalytic material 112. In this embodiment, the scraper 122 may operate by moving back and forth between brackets 120, while scraping and removing solid material from surfaces of the catalytic material 112. Suitable mechanical seals may be supplied to allow the central rotating mechanism 128 to pass through the inlet 110, outlet 108, or both the inlet 110 and outlet 108 of the reactor 100, so that the central rotating mechanism 128 may move the blades 124 in a radial direction. The scraper 122 may operate continuously or periodically to remove deposits of solid carbon and expose fresh surfaces of the catalytic material 112. During operation of the reactor 100, solids may be removed from the catalytic material 112 and collected, such as through the outlet 108. In some embodiments, an individual blade 124 may be connected to a spreader 126 on both ends of the blade 124. In other embodiments, a blade 124 may be connected to a spreader 126 on only one end of the blade 124. The spreader 126 may include holes or perforations to allow gases to flow through or adjacent the spreader 126.

In some embodiments, the scraper 122 may move in an up-and-down motion along the surfaces of the catalytic material 112 to remove solid material. In this embodiment, the blades 124 may be oriented in a horizontal position. An individual blade 124 may be connected to vertical shafts that push and pull the blade 124 along the surfaces of the catalytic material 112. In other embodiments, an individual blade 124 may be connected to spreaders 126 on both ends of the blade 124, wherein the spreaders push and pull the blades 124 along the surfaces of the catalytic material 112.

In some embodiments, the blades 124 may include full blades, as shown in FIG. 8, spanning a distance between surfaces of the catalytic material 112. In other embodiments, the blades 124 may include blade wires, wherein each blade 124 includes a plurality of blade wires spaced apart and wherein each blade wire is placed in proximity to one surface of the catalytic material 112.

The blades 124 may be made of a non-catalytic material resistant to the formation of solid carbon. In this embodiment, the scraper 122 may be more wear-resistant than the cartridge 114 and may need to be replaced less often than the cartridge 114. In other embodiments, the scraper 122 may be made of the same material as the catalytic material 112 in order to promote formation of nanostructured carbon. In this embodiment, the cartridge 114 and the scraper 122 may comprise a single unit that can be replaced together.

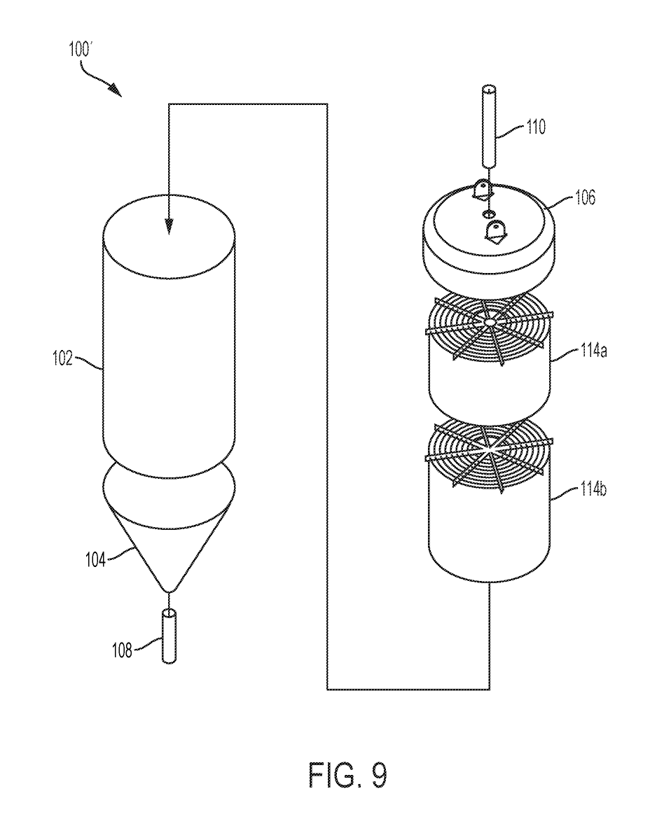

In some embodiments, a reactor 100′ may include multiple cartridges 114a and 114b, as shown in FIG. 9. The cartridges 114a and 114b may be stacked one on top of the other. In some embodiments, the cartridges 114a and 114b may comprise different catalyst materials or configurations to promote different reactions or reactions at different temperatures. In other embodiments, the cartridges 114a and 114b may comprise the same catalyst material or configuration.

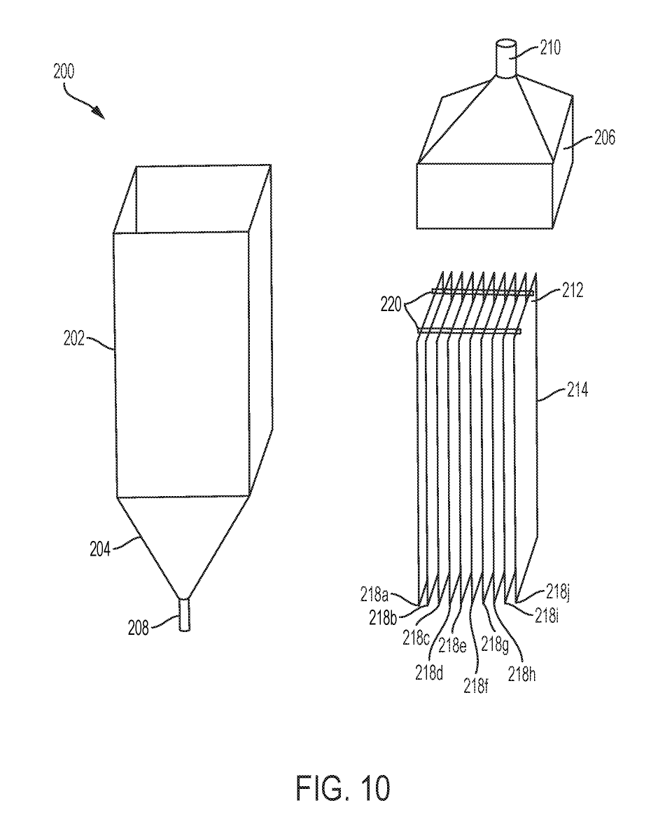

Though the reactors 100, 100′ and associated components are shown in FIGS. 2-9 having a cylindrical shape, the reactors 100, 100′ may be any appropriate shape. For example, FIG. 10 illustrates a reactor 200 having a prismatic shape. The reactor 200 includes an outer shell comprising a body 202, a base 204, and a cap 206. The body 202 and the base 204 may be integrally formed (e.g., welded together), and the cap 206 may be separately formed, as shown in FIG. 10. In some embodiments, the body 202, base 204, and cap 206 may each be separable from one another. The base 204 may define an outlet 208 from the reactor 200, and the cap 206 may define an inlet 210 to the reactor 200. Catalytic material 212 is configured to be placed within the body 202, and may be in the form of a cartridge 214. The cartridge 214 may be removable to facilitate replacement or renewal of the catalytic material 212. Though shown in exploded view for clarity, when the reactor 200 is in operation, the cartridge 214 and the catalytic material 212 are disposed within the body 202, and the cap 206 is secured to the body 202 to form a single unitary reactor shell. The reactor 200 may include a diffuser, such as the diffuser 116 shown in FIG. 3. The diffuser 116 may be shaped to correspond to a cross-sectional shape of the body 202 or the cap 206.

The cartridge 214 may includes multiple parallel plates 218a-218j of catalytic material. The plates 218a-218j may be sheets of catalytic material, or may be sheets of a substrate coated with a catalytic material. The plates 218a-218j define a plurality of flow paths through the reactor 200, from the inlet 210 to the outlet 208. The plates 218a-218j may be held in place by one or more brackets 220. The brackets 220 shown in FIG. 10 includes parallel bars, to which the plates 218a-218j are secured. The cartridge 214 may include multiple brackets 220, such as two brackets 220 at the top of the plates 218a-218j, and, optionally, two brackets 220 at the bottom of the plates 218a-218j. The brackets 220 may be configured to hang over a portion of the body 202, such that the plates 218a-218j are suspended within the body 202.

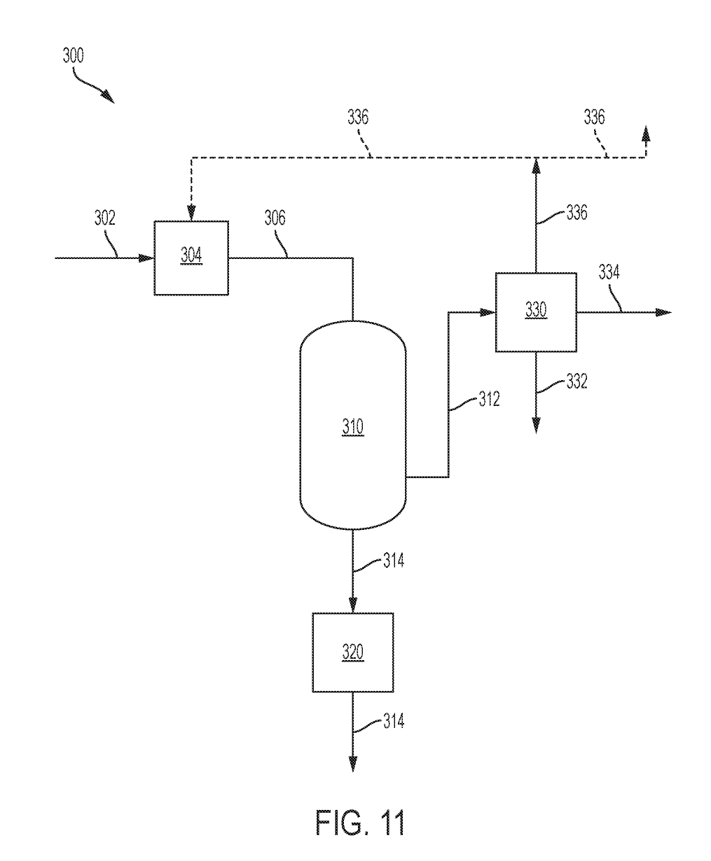

FIG. 11 schematically illustrates a system 300 for forming solid carbon. The system 300 includes a preconditioner 304, which prepares a source gas 302 for processing, such as by heating or compressing the source gas 302 to form a reactive gas 306. The reactive gas 306 enters a reactor 310, wherein at least a portion of the reactive gas 306 reacts to form a solid product 314. The reactor 310 may be, for example, any of the reactors 100, 100′, 200 described above and shown in FIGS. 2 and 10, respectively. The reactor 310 may have a primary axis, such as an axis defined by the gas inlet and solids outlet of the reactor 310 (see FIGS. 2 and 10). The reactor 310 may be oriented such that the primary axis is in an approximately vertical direction. Such an orientation allows the solid product 314 formed in the reactor 310 to fall toward the outlet to assist in collection.

The solid product 314 flows to a solids removal device 320, through which the solid product 314 is removed from the system 300. The solids removal device 320 may include, for example, a lock hopper, as described in U.S. Patent Application Publication 2016/0016800, published Jan. 21, 2016, and titled “Reactors, Systems and Methods for Forming Solid Products,” the entire disclosure of which is hereby incorporated by this reference. The solids removal device 320 may also include a means for cooling the solid product 314 to a temperature below the oxidation temperature of the solid product 314 in air prior to discharging. A lock hopper system or other separation means may control the release of gases to the atmosphere and may purge the solid product 314 of gaseous reactants prior to removal of the solid product 314 from the system 300. Other suitable means that conserve gaseous reactants and minimize worker and environmental exposure to the gaseous reactants may be used for removing the solid product 314 from the system 300.

The system 300 may optionally include other equipment for processing tail gases, water, or unreacted portions of the reactive gas 306. For example, the system 300 may include an outlet for tail gases 312. Tail gases 312 may be filtered, water may be condensed therefrom, and the tail gases 312 may then be purged or recycled. Heat may be added to or removed from tail gases 312, as appropriate for process control. Systems for processing tail gases 312 are described in, for example, U.S. Patent Application Publication 2016/0016800, previously incorporated by reference.

In some embodiments, water leaving the system 300, such as in the tail gases 312, is used within the system 300. For example, water may be used to control heat flow (e.g., in a heat exchanger).

The tail gases 312 may enter a separation subsystem 330, which is configured to separate solids, liquids, and/or gases. The separation subsystem 330 may be configured to remove solids 332 and water 334 from the tail gases 312 to form a recycle gas 336. The separation subsystem 330 may include any device operable to separate particulate matter from gases. For example, the separation subsystem 330 may include a cyclone, a scrubber, an elutriator, a filter, an electrostatic precipitator, a bag house, a condenser, etc., or any combination thereof. The recycle gas 336 leaving the separation subsystem 330 may be substantially free of solids. For example, the recycle gas 336 may include less than about 1%, less than about 0.1%, or even less than about 0.05% solids by mass. Techniques for separation of solids from liquids and gases depend upon the operating conditions of the reactor 310 and the expected composition of the tail gas 312. The separation subsystem 330 may include two or more devices operated in series or parallel to provide a selected purity (i.e., absence of solids) of the recycle gas 336, such as to allow recycle or even safe venting of the recycle gas 336.

Heat may be recovered from the solid product 314, the water 334, the recycle gas 336, or any other material within the system 300, such as by passing the material through one or more heat exchangers. Such heat recovery may be an effective way to recover a portion of the process heat and help bring the reactants to reaction temperature. Any gas or liquid streams may be processed as known in the art for overall energy optimization. The tail gas 312 may be maintained above the dew point of the water vapor in the tail gas 312 prior to separation of the solids 332 from the water 334 and the recycle gas 336 to limit or prevent the condensation of water in or on the solids 332.

The system 300 may include appropriate process controls, such as sensors, valves, heaters, pressure regulators, controllers, etc., which are generally known in the art and not described in detail herein. The system 300 may include one or more heaters or heat exchangers configured to provide the heating needs of the system 300, such as to regulate a temperature in the reactor 310. The system 300 may also include one or more refrigeration systems or condensers configured to provide the cooling needs of the system 300. The system 300 may include a compressor or pump for regulating pressure within the reactor 310. The system 300 may include one or more flow meters or valves for regulating the composition, flow rate, and/or pressure of the reactive gas 306 to the reactor 310.

In some embodiments, the reactor 310 may include two or more reactors configured to operate in series. Each reactor may be configured and operated to optimize formation of solid carbon and water, and water may be removed between the two reactors. Removal of water produced in a reaction of reactive gases may promote reactions that produce carbon (e.g., CH_{4(g)}+CO_{2(g)}↔2C₍ₛ₎+2H₂O_{(g)} by shifting the equilibrium of such reactions. Appropriate separation equipment, compressors, heaters, coolers, etc., may be used between reactors, such as the separation subsystem 330 described herein.

The reactors and systems described herein may be used to produce solid carbon products. When carbon-containing gases contact a catalyst material under suitable conditions of temperature and pressure, the carbon-containing gases decompose to form solid carbon. The allotrope and morphology of the solid carbon may be controlled by controlling the reactive gas composition, reaction temperature, and reaction pressure. Several reactions are commonly used to produce solid carbon, including hydrocarbon pyrolysis, the Boudouard reaction, the Bosch reaction, and related reactions. Such reactions are disclosed in, for example, U.S. Pat. No. 8,679,444, previously incorporated by reference.

By selecting the catalyst and the reaction conditions, the process may be “tuned” to produce selected morphologies of solid carbon products. In some embodiments, the catalyst may be formed over a substrate or support, such as an inert oxide that does not participate in the reactions. However, the substrate is not necessary; in other embodiments, the catalyst material is an unsupported material, such as a sheet of bulk metal.

Carbon activity (A_{c}) can be used as an indicator of whether solid carbon will form under particular reaction conditions (e.g., temperature, pressure, reactants, concentrations). While not intending to be bound by theory, it is believed that carbon activity is an important metric for determining which allotrope of solid carbon is formed. Higher carbon activity tends to result in the formation of CNTs and carbon nanofibers; lower carbon activity tends to result in the formation of graphitic forms.

Carbon activity for a reaction forming solid carbon from gaseous reactants can be defined as the reaction equilibrium constant times the partial pressure of gaseous products, divided by the partial pressure of reactants. For example, in the reaction, CH_{4(g)}+CO_{2(g)}2C₍ₛ₎+2H₂O_{(g)}, with a reaction equilibrium constant of K, the carbon activity A_{c} is defined as K.(P_{H2O}²/P_{CO2}.P_{CH4}). Thus, A_{c} is directly proportional to the square of the partial pressure of H₂O, and inversely proportional to the partial pressures of CH₄ and CO₂. The carbon activity of this reaction may also be expressed in terms of mole fractions and total pressure: A_{c}=K. P_{T}(Y_{H2O}²/Y_{CH4}.Y_{CO2}), where P_{T} is the total pressure and Y is the mole fraction of a species. Carbon activity generally varies with temperature because reaction equilibrium constants vary generally with temperature. Carbon activity also varies with total pressure for reactions in which a different number of moles of gas are produced than are consumed. Mixtures of solid carbon allotropes and morphologies thereof can be achieved by varying the catalyst(s) and the carbon activity of the gaseous reactants in the reactor.

The reaction conditions, including the temperature and pressure in the reaction zone, the residence time of the gaseous reactants, and the grain size, grain boundary, and chemical composition of the catalyst(s) may be controlled to obtain solid carbon products having selected characteristics. In some embodiments, the recycle gas 336 or a portion thereof is recycled through the reaction zone and passed through a condenser with each cycle to remove excess water and to control the partial pressure of the water vapor in the reactor 310. Because the partial pressure of water vapor affects the carbon activity and at high concentrations (e.g., greater than about 20%) will poison the catalysts by oxidation, water vapor appears to affect the type and character (e.g., morphology) of solid carbon formed, as well as the kinetics of carbon formation. Thus, in some embodiments, the water vapor may be carefully controlled at or near a selected concentration in the reactor.

Reaction conditions of the reactor 310 (e.g., time, temperature, pressure, partial pressure of reactants, catalyst properties, etc.) may be optimized to produce a selected type, morphology, purity, homogeneity, etc., of the solid product 314. For example, conditions may be selected to promote the formation of CNTs. In some embodiments, the solid product 314 includes allotropes of carbon or morphologies thereof, including graphite, pyrolytic graphite, graphene, carbon black, fibrous carbon, buckminsterfullerenes, single-wall CNTs, or multi-wall CNTs. The reactor 310 may operate at any pressures including pressures from near vacuum to about 30,000 kPa (300 bar), such as from about 100 kPa (1.0 bar) to about 1000 kPa (10 bar). In general, higher pressures correspond to faster reaction rates and a shift in equilibrium for the desired products. The reactor 310 may operate at temperatures from about 500° C. to about 1200° C., such as from about 580° C. to about 675° C. or from about 650° C. to about 800° C.

Though the reactor 310 is shown in FIG. 11 as a single unit, the reactor 310 may include two or more reaction vessels. For example, one reaction vessel may operate at conditions favorable to a first step of a reaction, and another reaction vessel may operate at conditions favorable to a second step of a reaction. The reactor 310 may include any number of reaction vessels or regions in which materials may react, depending on the particular reactions expected to occur. Each reaction vessel may be configured and operated to optimize a reaction step. For example, reaction vessels may operate at different temperatures or pressures from one another, or may include different catalyst materials.

Some reactant concentrations in the system 300 may be selected to be stoichiometric or near-stoichiometric. That is, the gases may include concentrations and flow rates of reactants (carbon oxide, nitrogen, methane, etc.) that, if reacted to completion, would be entirely or almost entirely consumed. Other mixtures may be selected to react according to particular reactions or to obtain a particular product. The compositions of gases in some subsystems may be in a ratio other than near stoichiometric. The compositions of gases may be selected based on economics, process controls, environmental regulations, etc. In some embodiments, inert gases are present in the system 300, such as argon. In such cases, appropriate venting may control the accumulation of inert gases in the process gas streams if the system recirculates significant portions of the gas.

1. A reaction apparatus for use in solid carbon production, the apparatus comprising:
a reactor shell defining a reactor inlet and a reactor outlet; and
a plurality of substantially parallel surfaces of catalytic material disposed within the reactor shell structured and adapted to expose at least one contact surface to gaseous reactants within the reactor shell.

2. The apparatus of claim 1, wherein the substantially parallel surfaces of catalytic material comprise sheets of catalytic material.

3. The apparatus of claim 1, wherein the substantially parallel surfaces of catalytic material define a plurality of discrete flow paths through the reactor shell.

4. The apparatus of claim 1, further comprising a cartridge, wherein the plurality of substantially parallel surfaces of catalytic material are disposed within the cartridge.

5. (canceled)

6. The apparatus of claim 1, wherein the substantially parallel surfaces of catalytic material comprise concentric cylinders of the catalytic material.

7. The apparatus of claim 6, wherein the reactor shell is configured to promote substantially uniform gas flow through the reactor shell from the reactor inlet to the reactor outlet, wherein the gas flow is generally parallel to an axis of rotation of the cylinders of the catalytic material.

8. The apparatus of claim 6, wherein the substantially uniform gas flow through the reactor shell from the reactor inlet to the reactor outlet is in the turbulent regime.

9. The apparatus of claim 1, wherein an interior surface of the reactor shell consists of a material that is not catalytic with the gaseous reactants at operating conditions of the apparatus.

10. The apparatus of claim 9, wherein the interior surface of the reactor shell comprises a coating configured to be in contact with the gaseous reactants, wherein the coating comprises a material that is not catalytic with the gaseous reactants.

11. The apparatus of claim 1, further comprising a diffuser structured and adapted to promote a substantially uniform gas flow of the gaseous reactants through the reactor shell from the reactor inlet to the reactor outlet.

12. The apparatus of claim 11, wherein the diffuser comprises a porous disk.

13. The apparatus of claim 11, wherein the diffuser comprises a sintered metal or ceramic disk comprising non-catalytic material.

14. The apparatus of claim 1, wherein the catalytic material comprises a material selected from the group consisting of iron, an iron compound, and an iron alloy.

15-16. (canceled)

17. The apparatus of claim 1, wherein the catalytic material comprises a material selected from the group consisting of nickel, a nickel compound, and a nickel alloy.

18. The apparatus of claim 1, further comprising a scraper configured to remove solid material from surfaces of the catalytic material.

19. The apparatus of claim 18, wherein the scraper comprises:
a plurality of blades disposed between and in proximity to surfaces of the plurality of substantially parallel surfaces of catalytic material;
a motion mechanism configured to translate the plurality of blades in a direction parallel to the surfaces of catalytic material; and
at least one spreader connecting the plurality of blades to the motion mechanism.

20. The apparatus of claim 1, wherein the catalytic material is substantially nonporous.

21. A plurality of reaction apparatuses of claim 1, arranged for operation in parallel.

22. The apparatus of claim 1, wherein the reactor shell has a primary axis, the reactor inlet and the reactor outlet disposed proximate the primary axis at opposing ends of the reactor shell, the primary axis oriented in an approximately vertical direction.

23. (canceled)

24. The apparatus of claim 1, wherein a portion of the reactor shell has an inverted pyramidal shape.
